(19) United States
(12) Patent Application Publication
(10) Pub. No.: US 2008/0036567 A1
(43) Pub. Date: Feb. 14, 2008

(54) METHOD OF CONTROLLING AN OPERATING TEMPERATURE OF EXISTING VEHICLE ENGINE COOLING FAN ON AND OFF CYCLES

(76) Inventor: Steven Glassburn, Clearwater, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/832,007

(22) Filed: Aug. 1, 2007

Related U.S. Application Data
(60) Provisional application No. 60/821,793, filed on Aug. 8, 2006.

(51) Int. Cl. H01H 37/00

(52) U.S. Cl. 337/1; 337/298

(57) ABSTRACT

A method and system of controlling an operating temperature of existing vehicle engine cooling fan on and off cycles includes the installation of a temperature sensor switch assembly to a coolant hose of a vehicle engine, electrically connecting the temperature sensor and switch assembly to one or more relays, and electrically connecting the relays to respective cooling fans of the vehicle engine. The temperature sensor and switch assembly is pre-set to cycle on and off at pre-determined temperatures or temperature ranges and can be adjustable to allow for individual control. In another embodiment, the sensor signal can be transmitted to the CPU/ECU, which in turn is wired to the relays, or transmitted directly to the relays as noted above.

### RELATED APPLICATION

This application claims the benefit of provisional patent application Ser. No. 60/821,793 filed Aug. 8, 2006.

### SUMMARY OF THE INVENTION

This invention was developed to specifically improve cooling system efficiency of various automobiles by altering the switch on and off points of the cooling fans. The invention is a cooling fan kit that operates as one unit and comprises relay(s) to control voltage sent to the cooling fan(s), a temperature sensor to monitor engine operating temperature, and a switch to send an appropriate signal to the relay(s) for fan operation. The switch may be integrated into the temperature sensor or a separate switch with user definable switching points is optionally incorporated into the kit for installation. These components are in electrical communication with appropriate wiring and connectors.

Traditionally the cooling fans of a automobile are controlled by factory-installed sensors that send signals to the engine control unit or central processing unit. These units send signals to factory-installed relays that control the fans based on factory specific operating temperatures.

Once the fan control kit is installed, it allows the user to determine at what temperature the automobiles cooling fans should become operational and allow the fans to come on sooner or later than originally programmed. This will allow for longer or shorter cooling times to the engine and other components. It does this by overriding the control from the factory ECU (engine control unit) or CPU (central processing unit) when the fans cycle on and off. By monitoring engine temperature and then using either a fixed temperature switch or user definable temperature switch, the user determines when the optional temperature for the fans will cycle on and off based on their environment.

Benefits of the present invention includes:

Extended Engine Life—Lower engine temperatures extend engine coolant seal life;
Better air-conditioning efficiency by lowering a/c condenser temperatures; and
Better Engine Compression—the Operating Temperatures of an engine will have a direct effect on engine compression.
   Reported Side Effects include:
Better starting after short-term parking;
More consistent idle due to higher compression and lower heat soak levels;
Better low RPM throttle response and horsepower increase due to higher engine compression; and
Colder air-conditioning temperatures.

The invention, which can be installed as a kit, will operate the cooling fans at a temperature determined optimal for the particular environment the vehicle operates in. It will also allow the user to determine when the factory installed cooling fans will operate by either an adjustable temperature switch or by a fixed temperature switch.

Accordingly, the invention is a method of controlling an operating temperature of existing vehicle engine cooling fan on and off cycles comprising the installation of a temperature sensor and switch assembly to a coolant hose of a vehicle engine. The assembly includes means for mechanically connecting the assembly to the coolant hose, such as a hose barbed mechanical fitting with clamps.

In one typical installation, the assembly is electrically connected to one or more relays, which are in turn in electrical communication with the cooling fans. That is, the wiring bypasses the vehicle ECU or CPU.

In another embodiment, the temperature sensor an switch assembly is electrically connected to respective connections in an engine control unit (ECU or CPU) of the vehicle engine that are in electrical communication with the relays, which are then wired to the cooling fans of the vehicle engine.

In either embodiment, the temperature sensor and switch assembly is pre-set to cycle on and off at pre-determined temperatures or temperature ranges.

The temperature sensor and switch assembly can be pre-set to cycle on when a coolant temperature reaches about 170-300° F and to cycle off when the coolant temperature lowers to about 175-275° F.

The temperature sensor and switch assembly can be provided with adjustable temperature feature or a fixed temperature feature.

The preferred embodiment is as described above regarding the direct wiring from the assembly to the relays and to the cooling fans, in which case, the invention includes a system for controlling an operating temperature of existing vehicle engine cooling fan on and off cycles comprising:

a temperature sensor and switch assembly, the assembly having means for mechanically connecting the assembly with an engine coolant hose using a fitting such as a hose barbed fitting with clamps;

one or more relays in electrical communication with the temperature sensor and switch assembly, the relays having means for electrically communicating with one or more respective cooling fans,

wherein the temperature sensor and switch assembly is pre-set to cycle on and off at pre-determined temperatures or temperature ranges.

### BRIEF DESCRIPTION OF THE DRAWINGS

In the accompanying drawing,

FIG. 1A is a schematic representation of a cooling fan system and modified according to the present invention, where the temperature sensor and switch assembly is wired to the relays, which are wired to the cooling fans, thereby by-passing an engine ECU or CPU; and

FIG. 1B is a schematic representation of a cooling fan system modified according to the present invention, where the temperature sensor and switch assembly is wired to the CPU or ECU unit of the vehicle and the CPU or ECU unit is then wired to the relays, which are then wired to the cooling fans.

### DETAILED DESCRIPTION OF THE INVENTION

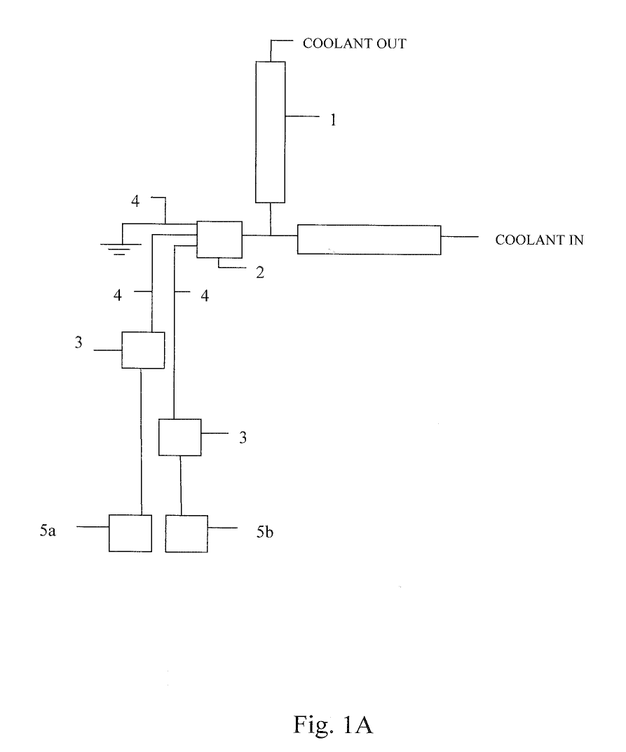

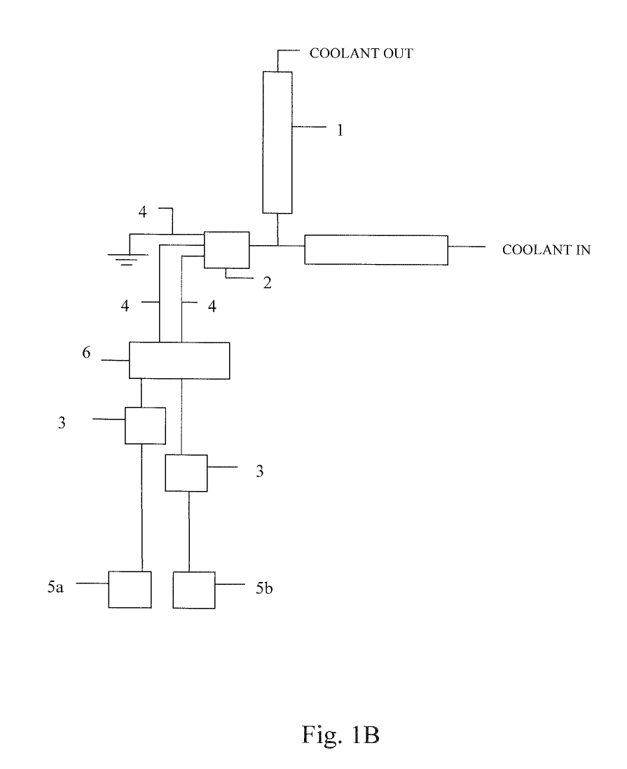

Referring now to the drawings, FIG. 1A is a representative schematic drawing depicting a preferred example of an installation arrangement, which includes the inventive kit or system. Depicted in FIG. 1A is a coolant bypass assembly, which typically includes a 90 degree hose fitting (tee) and a temperature sensor and switch assembly 2. Assembly 2 is installed using the mechanical fitting installed in the coolant hose 1. Relays 3 are wired between the cooling fans 5a, 5b. The temperature and sensor switch assembly 2 is wired so as to send electrical signals as necessary and are electrically connected using wires in wiring harness 4, one wire being connected to ground.

FIG. 1B is a representative schematic drawing depicting another example of an installation arrangement, which includes the inventive kit or system. Depicted in FIG. 1B is a coolant bypass assembly, which typically includes a 90 degree hose fitting (tee) and a temperature sensor and switch assembly 2. Assembly 2 is installed using the mechanical fitting installed in the coolant hose 1. Assembly is wired to the ECU or CPU 6 of the vehicle. ECU 6 is then electrically connected to the relays 3, which are wired to the cooling fans 5a, 5b. The temperature and sensor switch assembly 2 is wired so as to send ground signals as necessary and are electrically connected using wires in wiring harness 4, one wire being connected to ground.

Typical installation of the invention involves the following process:

a. First, raise the hood of the vehicle. Remove the battery cover and disconnect the negative battery cable.

b. Locate the coolant hose routed along the side of the ECU case and remove it from the holder.

c. Cut and remove the 90-degree bend from the hose leaving two straight pieces. (This is the section where the assembly 2 and its associated mechanical hose fitting is installed).

d. At least 1 inch of hose is typically needed to fit required hose clamps to fully engage the mechanical hose fitting to the cut ends of the coolant hose 1.

e. Slide the hose clamps (not shown) over each end of the cut hoses 1 and then slide the cut hose ends over the temperature and sensor switch assembly 2, also referred to herein as a temperature control tee 2.

f. Rotate assembly 2 so the attached wires are facing the passenger side of the car and tighten both hose clamps.

g. Connect the black wire with a ring connector or terminal (not shown) to the chassis by removing a bolt located just behind the ECU cover.

h. Slide the ring terminal onto the bolt, then replace and tighten the bolt to reestablish a ground connection.

i. Route the two relays 3 and wiring between the ECU case, battery box and along the front core support. (This is the piece of metal running across the front of the vehicle where the hood prop is attached).

j. Route the wiring towards the factory fuse/relay block on the drivers' side of the vehicle and secure the wiring with wire ties.

k. Remove the fuse block cover. Using the diagram on the underside of the lid, identifying the “cooling fan 1” and “cooling fan 2 relays”.

l. Remove these relays by gently lifting and wiggling each one individually from side to side. Set these two relays aside and now install the corresponding new relays 3 in the empty cooling fan sockets.

The wiring from the new relays should be routed towards the front of the fuse/relay block. An installer should be careful to make a small notch with a pocketknife or razor blade in the lower plastic lip to accommodate the relay wiring. The installer should verify that enough plastic material has been removed by installing the lid, removing the lid and verifying the wiring has not been cut or severely pinched.

The installer should also verify that there are no coolant leaks and the air separator tank, if the vehicle is equipped with one, is full.

Although the above description involves an example of the installation of a kit according to the embodiment of FIG. 1A, the installation for the embodiment of FIG. 1B is a simple modification to the above description.

Once installed, the engine can be started and allowed to reach normal operating engine temperature.

Both cooling fans should then begin to operate at the same time once the water reaches the pre-determined switch-on point. For example, if the factory installed switch-on point was about 206° F, then the new temperature/sensor switch assembly 2 will typically have a switch-on point of about 192-195° F, and both fans will stay running until the temperature drops below about 185° F. The fans will operate until the coolant drops below about 185° F regardless of A/C operation.

Assembly 2 can be adapted to have a switch which is adjustable or fixed. The adjustable switch will provide more individual control to the owner of the vehicle.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A method of controlling an operating temperature of existing vehicle engine cooling fan on and off cycles comprising:
installing a temperature sensor and switch assembly to a coolant hose of a vehicle engine, wherein said assembly includes means for mechanically connecting said assembly to said coolant hose;
electrically connecting said temperature sensor and switch assembly to one or more relays; and
electrically connecting said one or more relays to corresponding one or more cooling fans of said vehicle engine,
wherein said temperature sensor and switch assembly is pre-set to cycle on and off at pre-determined temperatures or temperature ranges.

2. The method according to claim 1, wherein said temperature sensor and switch assembly is pre-set to cycle on when a coolant temperature reaches about 170-300° F and to cycle off when said coolant temperature lowers to about 175-275° F.

3. The method according to claim 1, wherein said temperature sensor and switch assembly is one of an adjustable temperature sensor and switch assembly of fixed temperature sensor and switch assembly.

4. The method according to claim 3, wherein said temperature sensor and switch assembly is pre-set to cycle on when a coolant temperature reaches about 170-300° F and to cycle off when said coolant temperature lowers to about 175-275° F.

5. The method according to claim 1, further comprising:
electrically connecting an engine control unit of said vehicle engine between said temperature sensor and switch assembly and said one or more relays.

6. A system for controlling an operating temperature of existing vehicle engine cooling fan on and off cycles comprising:
a temperature sensor and switch assembly, said assembly includes means for mechanically connecting said assembly with an engine coolant hose;
one or more relays in electrical communication with said temperature sensor and switch assembly, said relays having means for electrically communicating with one or more respective cooling fans,
wherein said temperature sensor and switch assembly is pre-set to cycle on and off at pre-determined temperatures or temperature ranges.

7. The system according to claim 6, wherein said temperature sensor and switch assembly is pre-set to cycle on when a coolant temperature reaches about 170-300° F and to cycle off when said coolant temperature lowers to about 175-275° F.

8. The method according to claim 6, wherein said temperature sensor and switch assembly is one of an adjustable temperature sensor and switch assembly of fixed temperature sensor and switch assembly.

9. The system according to claim 8, wherein said temperature sensor and switch assembly is pre-set to cycle on when a coolant temperature reaches about 170-300° F and to cycle off when said coolant temperature lowers to about 175-275° F.

10. The system according to claim 6, wherein an engine control unit of said vehicle engine is electrically connected between said temperature and switch assembly and said relays.
